(19) United States
(12) Patent Application Publication
(10) Pub. No.: US 2018/0229660 A1
(43) Pub. Date: Aug. 16, 2018

(54) IMAGE DISPLAY DEVICE

(71) Applicant: Toyota Jidosha Kabushiki Kaisha, Toyota-shi Aichi-ken (JP)

(72) Inventors: Ryosuke Sugano, Toyota-shi Aichi-ken (JP); Masaaki Amano, Nagoya-shi Aichi-ken (JP)

(21) Appl. No.: 15/864,636

(22) Filed: Jan. 8, 2018

(30) Foreign Application Priority Data
Feb. 16, 2017 (JP) 2017-026887

(51) Int. Cl. B60R 1/12; B60R 1/04; H04N 5/232

(52) U.S. Cl. CPC B60R 1/12; B60R 1/04; H04N 5/23293; B60R 2300/8066; B60R 2300/70; B60R 2300/8046; B60R 2001/1253

(57) ABSTRACT

An image display device includes: a camera mounted on a movable member of a vehicle to take an image representing a surrounding of the vehicle; a display that displays the taken image; a state detector that detects a state of the movable member; and a controller that controls the display to display the taken image. The state detector detects that the state of the movable member is a first state and detects that the state of the movable member is a second state different from the first state. The controller controls the display to display the taken image when the state detected by the state detector is the first state. The controller controls the display not to display the taken image when the state detected by the state detector is the second state.

### CROSS REFERENCE TO RELATED APPLICATION

The present application claims priority from Japanese Patent Application No. 2017-026887, which was filed on Feb. 16, 2017, the disclosure of which is herein incorporated by reference in its entirety,

### BACKGROUND

The following disclosure relates to an image display device configured to control a display mounted in a passenger compartment to display an image representing a view behind a vehicle.

There is known an image display device configured to control a display mounted in a passenger compartment to display an image taken by a camera and representing a surrounding of a vehicle. Patent Document 1 (Japanese Patent Application Publication No. 2012-116357) discloses an image display device configured to cut out a portion of an image taken by a camera and display the cut-out image on a display.

### SUMMARY

In an image display device configured as described above, a camera is mounted on a vehicle so as to take a surrounding of the vehicle. In the case where the camera is mounted on a movable member such as a trunk lid and a back door, movement of the movable member in some cases changes a position of the camera from a position at which the camera is originally planned to take an image. Also, this camera is originally planned to take an image in stationary state in which the camera is at rest. In the case where the camera is mounted on the movable member, however, a display in some cases displays an image that is taken by the camera when the camera is not in the stationary state. Thus, the display in some cases displays an unnecessary image that is not an image originally planned to be taken.

Accordingly, an aspect of the disclosure relates to an image display device configured to prevent a display from displaying an unnecessary image by causing the display not to display an image taken by a camera when a movable member installed with the camera is in a state different from a state in which the camera is originally planned to take an image.

In one aspect of the disclosure, an image display device includes: a camera mounted on a movable member of a vehicle to take an image representing a surrounding of the vehicle; a display configured to display a taken image taken by the camera; a state detector configured to detect a state of the movable member; and a controller configured to control the display to display the taken image on a display region of the display. The state detector is configured to detect that the state of the movable member is a first state and detect that the state of the movable member is a second state different from the first state. The controller is configured to control the display to display the taken image when the state detected by the state detector is the first state. The controller is configured to control the display not to display the taken image when the state detected by the state detector is the second state.

There will be described by way of examples forms of aspects of the present disclosure. The forms are numbered like the appended claims and depend from another form or forms, where appropriate, for easy understanding of the present disclosure. It is to be understood that combinations of features of the present disclosure are not limited to those of the following forms. That is, the aspects of the present disclosure are to be construed by taking account of, e.g., the description following each form, the description of the embodiments, and conventional techniques, and as long as the aspects of the present disclosure are constructed in this way, any one of the following forms may be implemented with one or more features added, or one or more of a plurality of features included in any one of the following forms are not necessarily provided all together.

(1) An image display device, comprising:

a camera mounted on a movable member of a vehicle to take an image representing a surrounding of the vehicle;

a display configured to display a taken image taken by the camera;

a state detector configured to detect a state of the movable member; and

a controller configured to control the display to display the taken image on a display region of the display,

wherein the state detector is configured to detect that the state of the movable member is a first state and detect that the state of the movable member is a second state different from the first state,

wherein the controller is configured to control the display to display the taken image when the state detected by the state detector is the first state, and

wherein the controller is configured to control the display an to display the taken image when the state detected by the state detector is the second state.

Since the camera is mounted on the movable member, the image taken when the state of the movable member is the first state is different from the image taken when the state of the movable member is the second state. Here, the first state is a state of the movable member which is established when the camera takes an image originally planned to be taken. The second, state is a state of the movable member which is different from the state of the movable member which is established when the camera takes an image originally planned to be taken. In the present image display device, when the movable member is in the first state, the image taken in the first state is displayed on the display. When the movable member is in the second state, the image taken in the second state is not displayed on the display. This processing prevents the display from displaying an unnecessary taken image that is not a taken image originally planned to be taken, when the state of the movable member is the second state.

(2) The image display device according to the above form (1),

wherein the movable member is capable of selectively taking one of an open state and a closed state,

wherein the state detector is configured to detect that the state of the movable member is the first state, when the movable member is in the closed state, and

wherein the state detector is configured to detect that the state of the movable member is the second state, when the movable member is in the open state.

The closed state is a state of the movable member which is established when the camera takes an image originally planned to be taken. The open state is a state of the movable member which is different from the state of the movable member which is established when the camera takes an image originally planned to be taken. In the present image display device, when the state of the movable member is the closed state, the image taken in the closed state is displayed on the display When the state of the movable member is the open state, the image taken in the open state is not displayed on the display. This processing prevents the display from displaying an unnecessary taken image that is not a taken image originally planned to be taken, when the state of the movable member is the open state.

(3) The image display device according to the above form (1)

wherein the movable member configured to move between an open position and a closed position,

wherein the state detector is configured to detect that the state of the movable member is the first state, when the movable member is not moving between the open position and the closed position, and

wherein the state detector is configured to detect that the state of the movable member is the second state, when the movable member is moving between the open position and the closed position.

Since the camera is mounted on the movable member, the position of the camera changes with movement of the movable member. When the movable member is moving between the open position and the closed position, a display object in the image taken by the camera moves in the taken image. That is, even in the case where the vehicle is not moved, or the orientation of the vehicle is not changed, movement of the movable member moves the display object in the taken image, so that the camera takes an unnecessary image not relating to movement of the vehicle. In the present image display device, the taken image is displayed on the display when the movable member is not moving between the open position and the closed position, that is, when the movable member is at rest. When the movable member is moving between the open position and the closed position, the taken image is displayed on the display. This processing prevents the display from displaying an unnecessary taken image when the movable member is moving between the open position and the closed position, that is, when the movable member is not at rest.

(4) The image display device according to any one of the above forms (1) through (3), wherein the controller is configured to control the display to display an alternative image instead of the taken image, when the state of the movable member is the second state, and the alternative image is an image created in advance.

In the image display device configured as described above, when the movable member is in the second state, the display displays the alternative image without displaying the taken image. This processing prevents the display from displaying the taken image in the second state.

(5) The image display device according to the above form (4), wherein the controller is configured to, when the state of the movable member is the second state, control the display to display an image representing a display state of the display, as the alternative image,

In the image display device configured as described above, it is possible to notify an occupant of the vehicle about the display state of the display when the movable member is in the second state.

(6) The image display device according to the, above form (5), wherein the image representing the display state of the display comprises an image representing that the display is in an OFF state in which the taken image is not displayed on the display.

In the image display device configured as described above, it is possible to clearly notify the occupant of the vehicle about a state in which the taken image is not displayed on the display

(7) The image display device according to the above form (4), wherein the controller is configured to, when the state of the movable member is the second state, control the display to display an image representing that the state of the movable member is the second state, a the alternative image.

In the image display device configured as described above, it is possible to notify the occupant of the vehicle that the movable member is in the second state.

(8) The image display device according to any one of the above forms (1) through (7), wherein the movable member is one of a trunk lid and a back door.

In the image display device configured as described above, the taken image is not displayed on the display when the state of the trunk lid or the back door is the second state that is a state different from a state of the trunk lid or the back door in which the camera is originally planned to take an image. This processing prevents the display from displaying an unnecessary taken image.

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIG. 1A is a perspective view of a front side of a vehicle in a first embodiment;

FIG. 1B is a perspective view of a rear side of the vehicle in the first embodiment;

FIG. 2 is a schematic view of electric connection of a controller in the first embodiment;

FIG. 3A is a view of the vehicle and a display object located behind the vehicle, with the vehicle and the display object viewed in a direction parallel with the horizontal direction;

FIG. 3B is a view of a display displaying a taken image in a closed state of a back door of the vehicle;

FIG. 3C is a view of the display displaying the taken image in an open state of the back door of the vehicle;

FIG. 4A is a view of the display displaying a black image;

FIG. 4B is a view of the display displaying a display-state notifying image;

FIG. 4C is a view of the display displaying an open/closed-state notifying image;

FIG. 5 is a flow chart representing an image switching processing executed by a controller in the first embodiment;

FIG. 6A is a perspective view of a front side of a vehicle in a second embodiment;

FIG. 6B is a perspective view of a rear side of the vehicle in the second embodiment;

FIG. 7 is a schematic view of electric connection of a controller in the second embodiment; and

FIG. 8 is a flow chart representing an image switching processing executed by a controller in the second embodiment.

### DETAILED DESCRIPTION OF THE EMBODIMENTS

Hereinafter, there will be described embodiments by reference to the drawings.

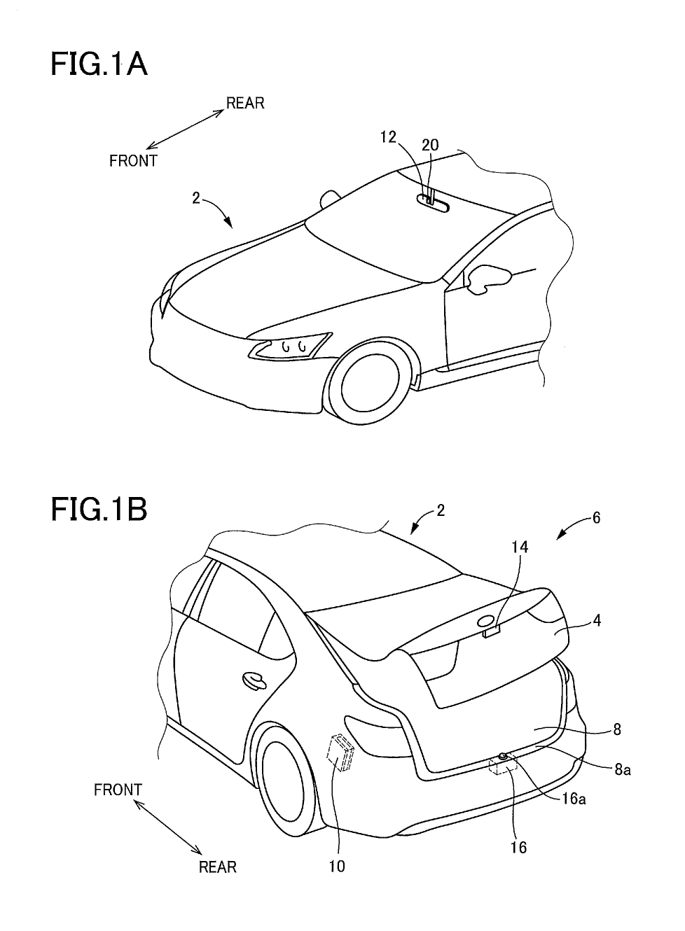

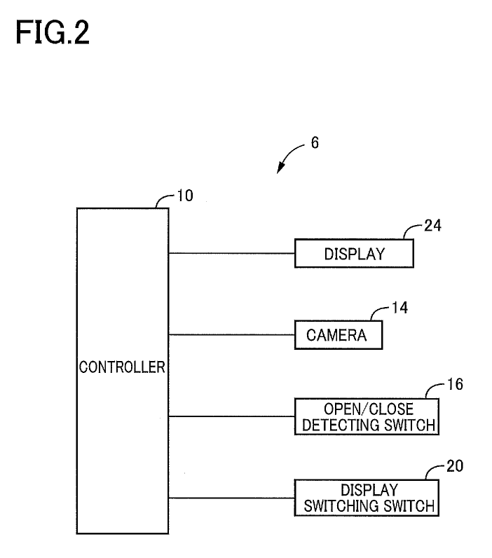

FIG. 1A is a perspective view of a front side of a vehicle 2 installed with an image display device 6 according to a first embodiment. FIG. 1B is a perspective view of a rear side of the vehicle 2. FIG. 2 is a schematic view of electric connection of a controller 10. As illustrated in FIGS. 1A and 1B, the vehicle 2 includes a back door 4 and the image display device 6. The image display device 6 includes the controller 10, a rear side display device 12, a camera 14, and an open/close detecting switch 16. As illustrated in FIGS. 1A and 1B, the front and rear direction is defined with respect to a direction of travel of the vehicle 2. This front and rear direction coincides with the longitudinal direction of the vehicle 2.

As illustrated in FIG. 1B, the back door 4 can (i) an opening portion of a trunk 8 provided in the vehicle 2 and GO an opening portion of a rear end portion of a passenger compartment of the vehicle 2. One end of the back door 4 is fixed to the vehicle 2. The back door 4 is pivotable about an axis extending through the one end fixed to the vehicle 2. A state of the back door 4 is switchable between a closed state and an open state. The closed state is a state in which the back door 4 fully covers the opening portion of the trunk 8 and the opening portion of the rear end portion of the passenger compartment. The open state is a state in which the trunk 8 and the rear end portion of the passenger compartment are exposed. This open state includes a half-open state of the hick door 4. That is, the back door 4 pivots between (i) a closed position at which the back door 4 is in the closed state and (ii) an open position at which the back door 4 is in the open state.

The controller 10 includes a central processing unit (CPU), a non-volatile memory (such as a ROM and an EEPROM), a RAM, various ICs, and communication interfaces. The controller 10 executes various controls by controlling the CPU to execute programs stored in the ROM. As illustrated in FIG. 2, devices communicably connected to the controller 10 include a display 24 which will be described below, the camera 14, the open/close detecting switch 16, and a display switching switch 20. The controller 10 controls the display 24 to display at least a portion of an image taken by the camera 14. When the controller 10 has received an ON signal from the open/close detecting switch 16, the controller 10 determines that the back door 4 is in the open state, and the controller 10 switches an image displayed on the display 24 from the taken image to an alternative image created in advance.

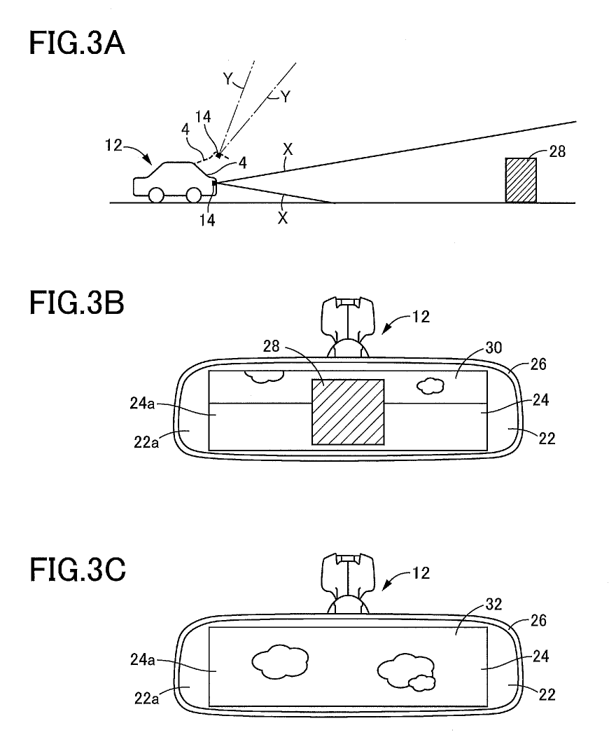

As illustrated in FIG. 1A, the rear-side display device 12 is mounted on a roof portion defining the passenger compartment. The rear-side display device 12 is disposed in front of a driver's seat and between the driver's seat and an assistant-driver's seat. As illustrated FIGS. 3B and 3C, the rear-side display device 12 includes a mirror surface 22, the display 24, and a frame 26. The mirror surface 22 has substantially the same size as the frame 26 and is fitted in the frame 26. The mirror surface 22 reflects a view behind the vehicle 2. The display 24 is formed in a portion of the mirror surface 22. The display 24 is smaller in size than the mirror surface 22 and disposed at substantially the center of the mirror surface (see FIG. 3C). That is, the mirror surface 22 includes: a mirror surface portion 24a formed on a surface of the display 24; and a mirror surface portion 22a located around the display 24. The display 24 display the taken image or the alternative image output from the controller 10.

In a state in which the display 24 is not operated, each of the mirror surface portion 24a and the mirror surface portion 22a serves as an optical mirror (a mirror surface showing state). In a state in which the display 24 is being operated, the image is displayed on the display 24 and viewable by an occupant (a display showing state). In the case where the mirror surface portion 24a and the mirror surface portion 22a reflect a rear-side view in a state in which the image is displayed on the display 24 in the display showing state, a viewability of the image displayed on the display 24 is reduced. Thus, the angle of the frame 26 is adjusted in the display showing state, such that the mirror surface 22 faces a ceiling of the vehicle 2 so as not to reflect the rear-side view.

As illustrated in FIG. 1B, the camera 14 is mounted on the back door 4 to at least rake an image in a visible light region. One example of the camera 14 is a CCD camera. The camera 14 is fixed to the back door 4 so as to take an image right behind the vehicle 2 in the closed state of the back door 4. The image taken by the camera 14 is output to the controller 10. The image taken by the camera 14 contains objects to be displayed which are located at a rear of the vehicle 2. The objects to be displayed may be hereinafter referred to as “display objects”.

The open/close detecting switch 16 includes a pushing member 16a and a switch casing, not, illustrated. The open/close detecting switch 16 is provided on a peripheral portion 8a of the vehicle 2 which defines the opening portion of the trunk 8. The switch casing of the open/close detecting switch 16 is imbedded in the vehicle 2 at the peripheral portion 8a. The pushing member 16a is exposed to an outside of the vehicle 2 at the peripheral portion 8a. The open/close detecting switch 16 outputs the ON signal to the controller 10 when the pushing member 16a is pushed into the switch casing. The pushing member 16a is pushed into the switch casing by the back door 4 when the back door 4 is in the closed state. On the other hand, the pushing member 16a is not pushed in the switch casing when the back door 4 is in the open state. Thus, the open/close detecting switch 16 detects the open state and the closed state of the back door 4. When the back door 4 is in the closed state, the open/close detecting switch 16 is in an ON state, and the controller 10 outputs the ON signal. When the back door 4 is in the open state (including the half open state), the open/close detecting switch 16 is in an OFF state, and the open/close detecting switch 16 stops outputting the ON signal to the controller 10.

As illustrated in FIG. 1A, the display switching switch 20 is provided at a position at which the rear side display device 12 and the roof portion of the vehicle 2 are connected to each other. The display switching switch 20 sends the controller 10 a signal for switching a display state (a view showing state) of the rear side display device 12 between the mirror surface showing state and the display showing state. An ON/OFF state of the display switching switch 20 is switched by the occupant. When the display switching switch 20 is switched to the ON state, the display state of the rear-side display device 12 is switched from the mirror surface showing state to the display showing state, so that the taken image is displayed on the display 24. When the display switching switch 20 is switched to the OFF state, the display state of the rear side display device 12 is switched from the display showing state to the mirror-surface showing state, so that the mirror surface 22 reflects a view behind the vehicle.

There will be next explained a relationship between opening/closing of the back door 4 and the taken image displayed on the display 24. FIG. 3A is a view of the vehicle 2 and a display object 28 located behind the vehicle 2, with the vehicle 2 and the display object 28 viewed in a direction parallel with the horizontal direction. FIG. 3B is a view of the display 24 displaying a taken image in the closed state of the back door 4 FIG. 3C is a view of the display 24 displaying a taken image in the open state of the back door 4. In FIG. 3A, boundary lines X indicated by the solid lines define an area taken by the camera 14 in the closed state of the back door 4. Boundary lines Y indicated by the one dot chain lines define an area taken by the camera 14 in the open state of the back door 4 indicated by the broken lines. That is, objects existing in the area between the two boundary lines X are contained in an image 30 taken by the camera 14 in the closed state of the back door 4. Objects existing in the area between the two boundary lines Y are contained in an image 32 taken by the camera 14 in the open state of the back door 4.

As illustrated in FIG. 3A, the angle of view and a shooting direction of the camera 14 are determined so as to take an image right behind the vehicle 2 in the closed state of the back door 4. That is, the camera 14 is set such that the display object 28 located right behind and at a distance from the vehicle 2 is displayed at substantially the center of the display 24 as illustrated in FIG. 3B. In the open state of the back door 4, a position of the camera 14 is changed from a position of the camera 14 in the closed state of the back door 4 in accordance with pivotal movement of the back door 4. When the back door 4 is swung from the dosed position to the open position illustrated in FIG. 3A, the camera 14 takes an image not right behind the vehicle 2 but above the vehicle 2. Thus, the display 24 ceases displaying the display object 28 and displays the sky above the vehicle 2.

The camera 14 is mounted on the openable/closable back door 4 as described above. Thus, even in the case where the vehicle 2 is located at the same point and faces in the same direction, the taken image displayed on the display 24 is different between the open state and the closed state of the back door 4. Accordingly, when the back door 4 is in the open state, the display 24 displays an unnecessary taken image 32 not containing the display object 28, thereby giving discomfort to a driver. To solve this problem, the controller 10 in the present embodiment executes an image switching processing. In this processing, the controller 10 controls the display 24 to display the taken image when the back door 4 is in the closed state, and the controller 10 controls the display 24 to display the alternative image instead of the taken image when the back door 4 is in the open state.

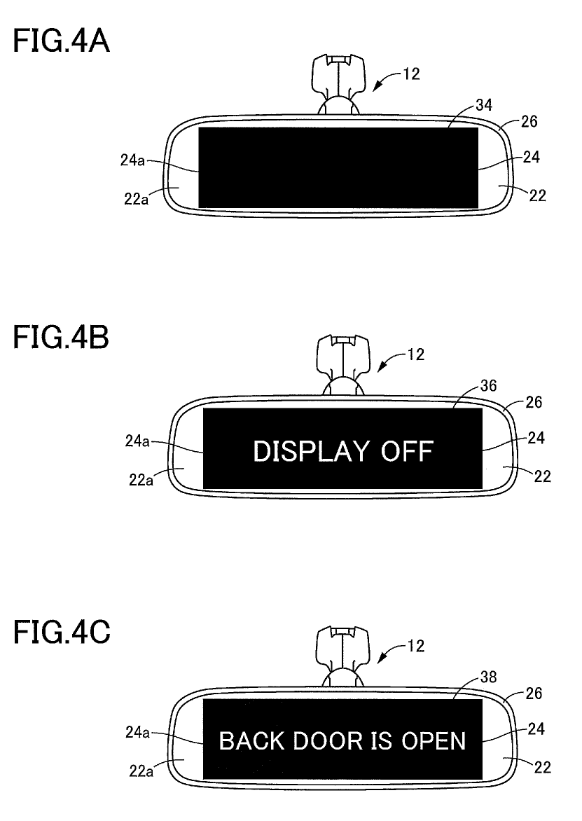

Here, there will be explained examples of the alternative image. FIG. 4A illustrates the display 24 displaying a black image 34. FIG. 4B illustrates the display 24 displaying a display-state notifying image 36. FIG. 4C illustrates the display 24 displaying an open/closed state notifying image 38. For example, the black image 34, the display state notifying image 36, and the open/closed state notifying image 38 are used as the alternative image. As illustrated in FIG. 4A, the black image 34 is a solid black image with no characters. As illustrated in FIG. 4B, the display-state notifying image 36 is an image with white characters on a black background, representing that the display 24 is in the OFF state in which the taken image is nut displayed. As illustrated in FIG. 4C, the open/closed-state notifying image 38 is an image with white characters on a black background, representing that the back door 4 is in the open state. The display state notifying image 36 and the open/closed state notifying image 38 are created in advance and stored in the ROM of the controller 10. When the state of the back door 4 is switched from the open state to the closed state, the display 24 ceases displaying the alternative image and displays the taken image.

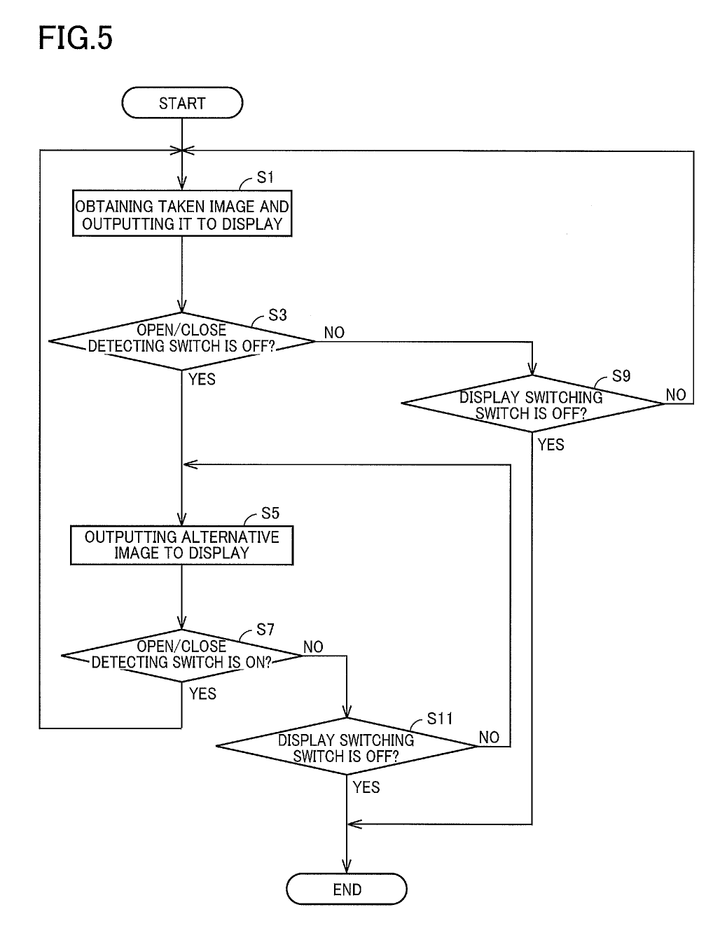

There will be next explained the image switching processing executed by the controller 10 with reference to a flow chart in FIG. 5. The flow chart in FIG. 5 represents the image switching processing executed by the controller 10. This flow begins when the state of the display switching switch 20 is switched to the ON state, that is, when the display state of the rear-side display device 12 is switched from the mirror-surface showing state to the display showing state. Also, the camera 14 starts taking an image when the state of the display switching switch 20 is switched to the ON state. At S1, the controller 10 obtains the taken image from the camera 14. The controller 10 executes processings for the obtained taken image, such as a processing hot changing the size of the taken image and a mirror-image processing for the taken image. The controller 10 then outputs the taken image to the display 24. The display 24 displays the received taken image.

The controller 10 at S3 determines whether the open/close detecting switch 16 is in the OFF state, that is, the controller 10 determines whether the back door 4 is in the open state. When the open/close detecting switch 16 is in the OFF state, the back door 4 is in the open state, and this flow goes to S5. When the open/close detecting switch 16 is not in the OFF state, the back door 4 is in the closed state, and this flow returns to S1 via S9 That is, when the back door 4 is in the closed state, the image taken by the camera 14 is output to the display 24 until the state of the back door 4 has become the open state. Here, the closed state of the back door 4 is a state established when the camera 14 takes an image representing a rear-side view (a view right behind the vehicle 2) which is originally planned to be taken. The open state of the back door 4 is different from the state (closed stats) of the back door 4 which is established when the camera 14 takes an image representing a re ii side view that is originally planned to be taken.

When the state of the back door 4 has become the open state, the controller 10 at S5 stops outputting the taken image to the display 24 and outputs the alternative image stored in the ROM to the display 24. As a result, the image displayed on the display 24 is switched from the taken image to the alternative image. At S7, the controller 10 determines whether the state of the open/close detecting switch 16 has become the ON state, that is, the controller 10 determines whether the state of the back door 4 has become the closed state. When the state of the open/close detecting switch 16 has become the ON state, this flow returns to S1. When the open/close detecting switch 16 is in the OFF state, this flow returns to S5 via S11. That is, when the state of the baa door 4 becomes the closed state, the image output to the display 24 is switched from the alternative image to the display image. When the back door 4 is in the open state, the alternative image is output to the display 24 until the state of the back door 4 becomes the closed state.

When a negative decision (NO) is made at S3, the controller 10 at S9 determines whether the display switching switch 20 is in the OFF state, that is, the controller 10 determines whether the display state of the rear-side display device 12 is switched from the display showing state to the mirror surface showing state. When the display switching switch 20 is in the OFF state, this flow ends. When the display switching switch 20 is in the ON state, this flow returns to S1. When a negative decision (NO) is made at S7, as in the processing at S9, the controller 10 at S11 determines whether the state of the display switching switch 20 has become the OFF state. When the state of the display switching switch 20 is in the OFF state, this flow ends. When the display switching switch 20 is in the ON state, this flow returns to S5.

In the configuration as described above, in the closed state of the back door 4, the camera 14 takes the image 30 required for the occupant of the vehicle to check a rear side of the vehicle 2. Since the camera 14 is mounted on the back door 4, the image 32 taken by the camera 14 in the open state of the back door 4 is different from the image 30 taken by the camera 14 in the closed state of the back door 4. That is, the image 32 taken by the camera 14 in the open state of the back door 4 is an unnecessary image that is not the taken image 30 originally planned to be taken. In the present embodiment, when the back door 4 is in the closed state, the image 30 taken in the closed state is displayed on the display 24. When the back door 4 is in the open state, the image 32 taken in the open state is not displayed on the display 24. Accordingly, it is possible to prevent the display 24 from displaying the unnecessary taken image when the back door 4 is in the open state.

Also, when the back door 4 is in the open state, the controller 10 controls the display 24 to display the alternative image without displaying the taken image 32. This processing prevents the display 24 to display the image 32 taken in the open state of the back door 4. In the case where the display state notifying image 36 is displayed on the display 24 as the alternative image when the back door 4 is in the open state, it is possible to notify the occupant of the vehicle 2 of a state in which the taken image is not displayed on the display 24. In other words, it is possible to notify the occupant of the vehicle 2 that the display 24 ceases displaying the taken image due to an operation for opening the back door 4.

In the case where the open/closed-state notifying image 38 is displayed on the display 24 as the alternative image when the back door 4 is in the open state, it is possible to notify the occupant of the open state of the back door 4. Also, since the image taken by the camera 14 is not displayed on the display 24 when the back door 4 is in the open state, it is possible to prevent the display 24 from displaying the unnecessary image when the back door 4 is in the open state.

### Second Embodiment

There will be next explained, a second embodiment. In the first embodiment, the controller 10 switches the image displayed on the display 24 when one of the open state and the closed state of the back door 4 is detected by the open/close detecting switch 16. In the second embodiment, in contrast, the controller 10 uses an actuation sensor 116, which will be described below, to detect that the back door 4 is moving between the open position and the closed position, and the controller 10 switches the image displayed on the display 24 from the taken image to the alternative image during the movement of the back door 4. The back door 4, the controller 10, the rear side display device 12, and the camera 14 in the second embodiment are similar in configuration to those in the first embodiment, and an explanation of which is dispensed with.

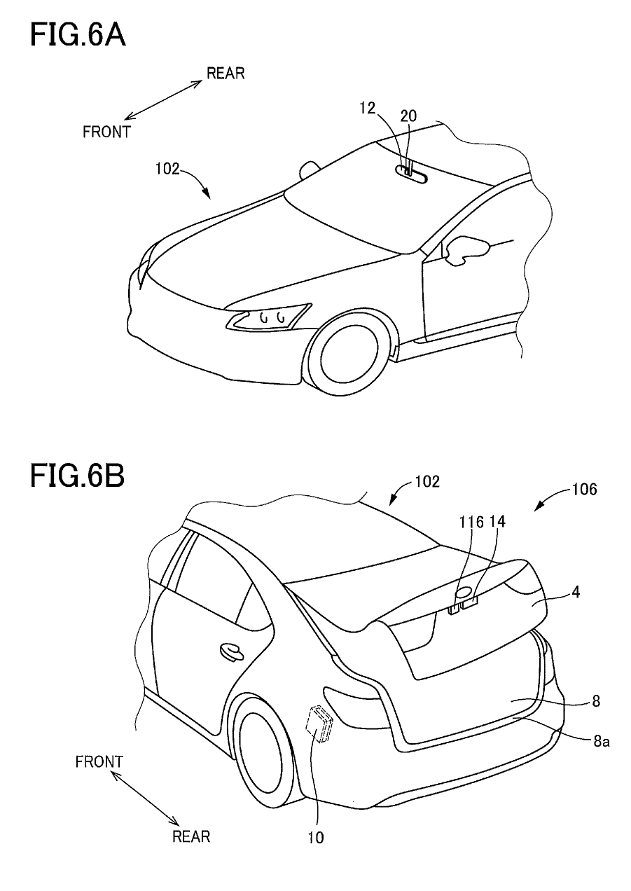

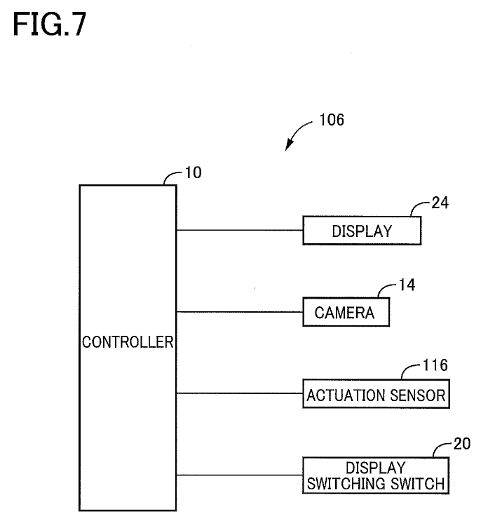

FIG. 6A is a perspective view of a front side of a vehicle 102 installed with an image display device 106 according to the second embodiment. FIG. 6B is a perspective view of a rear side of the vehicle 102. FIG. 7 is a schematic view of electric connection of the controller 10. As illustrated in FIGS. 6A and 6B, the vehicle 102 includes the back door 4 and the image display device 106. The image display device 106 includes the controller 10, the rear-side display device 12, the camera 14, and the actuation sensor 116. As illustrated in FIGS. 6A and 6B, the front and rear direction is defined with respect to a direction of travel of the vehicle 102. As illustrated in FIG. 7, the camera 14, the display 24, and the actuation sensor 116 are communicably connected to the controller 10.

The actuation sensor 116 is disposed near the camera 14 mounted on the back door 4. The actuation sensor 116 senses pivotal movement of the back door 4. One example of the actuation sensor 116 is a G sensor configured to detect acceleration of the back door 4 during it pivotal movement. The actuation sensor 116 outputs a detection value to the controller 10 in accordance with the pivotal movement of the back door 4. When the detection value of the actuation sensor 11$ is greater than or equal to a threshold value, the controller 10 detects that the back door 4 is pivoting between the open position and the closed position. When the detection value of the actuation sensor 116 is less than the threshold value, the controller 10 detects that the back door 4 is not pivoting between the open position and the closed position, that is, the controller 10 detects that the back door 4 is at rest at the open position or the closed position. The threshold value is a value which is set for the controller 10 to determine whether the back door 4 is pivoting, based on the magnitude of acceleration of the back door 4 during pivotal movement of the back door 4, which acceleration is calculated based on the detection value of the actuation sensor 116.

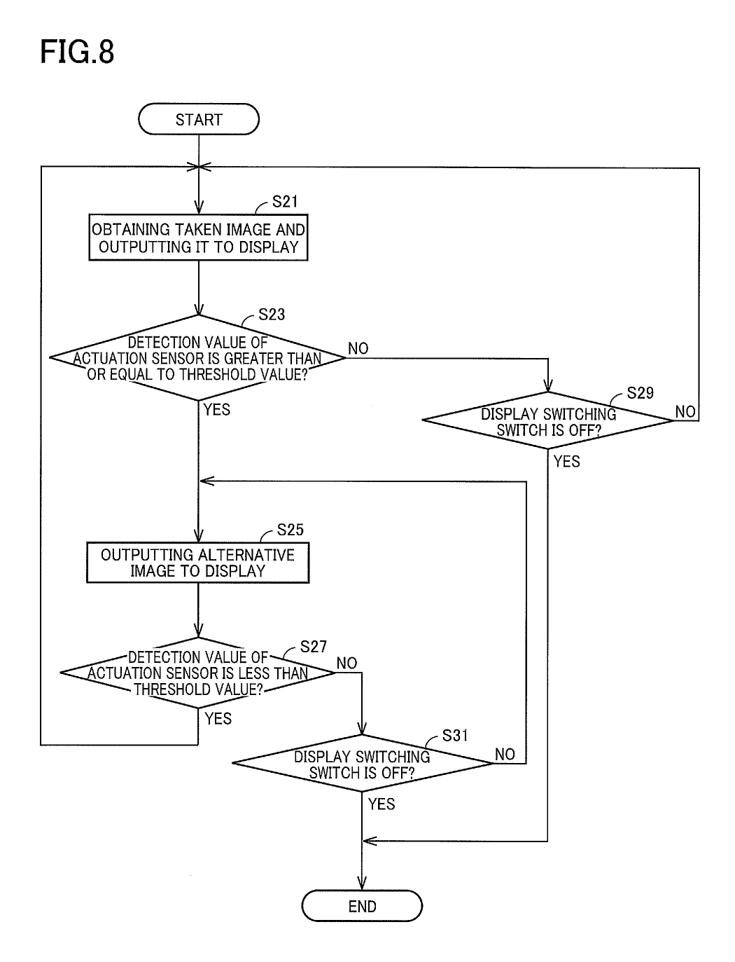

The flow chart in FIG. 8 represents a display switching processing executed by the controller 10. This flow begins when the state of the display switching switch 20 is switched to the ON state. Also, the camera 14 starts taking an image when the state of the display switching switch 20 is switched to the ON state. At S21, the controller 10 obtains the taken image from the camera 14. The controller 10 executes processings for the obtained taken image, such as a processing for changing the size of the taken image and a mirror image processing for the taken image. The controller 10 then outputs the taken image to the display 24.

The controller 10 at S23 obtains the detection value of the actuation sensor 116 and determines whether the obtained detection value is greater than or equal to the threshold value, that is, the controller 10 determines whether the back door 4 is pivoting between the open position and the closed position. When the detection value of the actuation sensor 116 is greater than or equal to the threshold value, the back door 4 is in a pivoting state in which the back door 4 is pivoting between the open position and the closed position, and this flow goes to S25. When the detection value of the actuation sensor 116 is less than the threshold value, the back door 4 is in a stationary state in which the back door 4 is not pivoting between the open position and the closed position, that is, the back door 4 is at rest at the open position or the closed position, and this flow returns to S21 via S29. That is, when the back door 4 is in the stationary state, the image taken by the camera 14 is output to the display 24 until the back door 4 becomes the pivoting state. Here, the stationary state of the back door 4 is a state established when the camera 14 takes an image of a view originally planned to be taken. The pivoting state of the back door 4 is different from the state (stationary state) of the back door 4 which is established when the camera 14 takes an image of a view originally planned to be taken.

When the back door 4 is pivoting between the open position and the closed position, the controller 10 at S25 stops outputting the taken image to the display 24 and outputs the alternative image stored in the ROM to the display 24. As a result, the image displayed on the display 24 is switched from the taken image to the alternative image. For example, the black image, the display-state notifying image, and the open/closed-state notifying image are used as the alternative image. At S27, the controller 10 determines whether the detection value of the actuation sensor 116 is less than the threshold value, that is, the controller 10 determines whether the back door 4 is in the stationary state. When the detection value of the actuation sensor 116 is less than the threshold value, this flow returns to S21. When the detection value of the actuation sensor 116 is greater than or equal to the threshold value, this flow goes to S25 via S31. That is, when the state of the back door 4 has become the stationary state, the image output to the display 24 is switched from the alternative image to the display image. When the back door 4 is in the pivoting state, the alternative image is output to the display 24 until the state of the back door 4 becomes the stationary state.

When a negative, decision (NO) is made at S23, the controller 10 at S29 determines whether the display switching switch 20 is in the OFF state, that is, the controller 10 determines whether the display state of the rear-side display device 12 is switched from the display showing state to the mirror-surface showing state. When the display switching switch 20 is in the OFF state, this flow ends. When the display switching switch 20 is in the ON state, this flow returns to S21. When a negative decision (NO) is made at S27, as in the processing at S29, the controller 10 at S31 determines whether the state of the display switching switch 20 has become the OFF state. When the display switching switch 20 is in the OFF state, this flow ends. When the display switching switch 20 is in the ON state, this flow returns to S25.

In the configuration as described above, the camera 14 is mounted on the back door 4. Thus, the position of the camera 14 is changed in accordance with pivotal movement of the back door 4. In this change, the display object 28 is moved in the image taken by the camera 14 by the change of the position of the camera 14 and disappears from the taken image. That is, even in the case where the vehicle 2 is not moved, or the orientation of the vehicle 2 is not changed, pivotal movement of the back door 4 moves the display object 28 in the taken image, so that the camera 14 takes an unnecessary image not relating to movement of the vehicle 2. In the present embodiment, when the back door 4 is not pivoting between the open position and the closed position, that is, when the back door 4 is at rest at the open position or the closed position, the display 24 displays the taken image. When the back door 4 is pivoting between the open position and the dosed position, the display 24 does not display the taken image. This processing prevents the display 24 from displaying the unnecessary taken image during change of the position of the camera 14 in accordance with pivotal movement of the back door 4.

When the back door 4 is pivoting between the open position and the closed position, the controller 10 controls the display 24 to display the alternative image without displaying the taken image 32. This processing prevents the display 24 from displaying the taken image during pivotal movement of the back door 4 between the open position and the closed position. Also, in the case where the display state notifying image 36 is displayed on the display 24 as the alternative image during pivotal movement of the back door 4 between the open position and the closed position, it is possible to notify the occupant of the vehicle 2 of the state in which the taken image is not displayed on the display 24. In other words, it is possible to notify the occupant of the vehicle 2 that the display 24 ceases displaying the taken image due to pivotal movement of the back door 4.

In the case where the open/closed-state notifying image 38 is displayed on the display 24 as the alternative image during pivotal movement of the back door 4 between the open position and the closed position, it is possible to notify the occupant of the open state of the back door 4. Since the image taken by the camera 14 is not displayed on the display 24 dining pivotal movement of the back door 4 between the open position and the closed position, it is possible to prevent the display 24 from displaying the unnecessary image during pivotal movement of the back door 4 between the open position and the closed position.

In the first and second embodiments, the back door 4 is one example of a movable member. Each of the closed state of the back door 4 and the state of the back door 4 in which the back door 4 is not pivoting between the open position and the closed position is one example of a first state. Each of the open state of the back door 4 and the state of the back door 4 in which the back door 4 is pivoting between the open position and the closed position is one example of a second state. Each of the open/close detecting switch 16 in the first embodiment and the actuation sensor 116 in the second embodiment is one example of a state detector.

While the embodiments have been described above, it is to be understood that the disclosure is not limited to the details of the illustrated embodiment, but may be embodied with various changes and modifications, which may occur to those skilled in the art, without departing from the spirit and scope of the disclosure. While the camera 14 is disposed on the back door 4 in the first and second embodiments, the present disclosure is not limited to this configuration. The movable member mounted on the camera 14 may be any member as long as the member is provided so as to move relative to the vehicle. For example, the movable member may be provided on a trunk lid openably mounted on the vehicle. The movable member may be a rotational member rotatably mounted on the vehicle or a slide member slidably mounted on the vehicle.

While the camera 14 is mounted on the movable member provided on the rear end portion of the vehicle, the present disclosure is not limited to this configuration. For example, the camera 14 may be mounted on a door mirror a side mirror) provided on a side surface portion of the vehicle. In the case where the camera 14 is provided on the door mirror, when the door mirror is in an open state in which the door mirror is unfolded, the camera 14 takes an image originally planned to be taken, and accordingly the display 24 displays the taken image. When the door mirror is in a closed state in which the door mirror is folded, the state of the door mirror is different from the state of the door mirror in which the camera 14 takes an image originally planned to be taken, and accordingly the display 24 displays the alternative image. Alternatively, the image display device may be configured such that when the door mirror is at rest at the open position or the closed position, the display 24 displays the taken image, and when the door mirror is moving between the open position and the closed position, the display 24 displays the alternative image.

While the actuation sensor 116 is the G sensor in the second embodiment, the actuation sensor 116 at least needs to detect movement of the back door 4. For example, the actuation sensor 116 may be a gyrosensor configured to detect movement of the back door 4 by detecting an angular velocity about an axis. Also, the actuation sensor 116 may be a positional sensor configured to detect a position of the back door 4. When the position of the back door 4 which is detected by the positional sensor is constant, the back door 4 is in the stationary state. When the position of the back door 4 changes, the back door 4 is in the pivoting state.

In the first and second embodiments, when the open state or the pivoting state of the back door 4 is detected, the controller 10 controls the display 24 to display the alternative image, but the present disclosure is not limited to this configuration. The image display device may be configured such that, when the open state or the pivoting state of the back door 4 is detected, the controller 10 stops an operation of the display 24 to display no images. That is, the controller 10 does not display the taken image on the display 24. This processing prevents the display 24 from displaying the unnecessary taken image. In this case, when the controller 10 has detected the closed state of the back door 4 or detected that the back door 4 is not pivoting between the open position and the closed position, the controller 10 activates the display 24 to display the taken image again.

What is claimed is:

1. An image display device, comprising:
a camera mounted on a movable member of a vehicle to take an image representing a surrounding of the vehicle;
a display configured to display a taken image taken by the camera;
a state detector configured to detect a state of the movable member; and
a controller configured to control the display to display the taken image on a display region of the display,
wherein the state detector is configured to detect that the state of the movable member is a first state and detect that the state of the movable member is a second state different from the first state,
wherein the controller is Configured to control the display to display the taken image when the state detected by the state detector is the first state, and
wherein the controller is configured to control the display not to display the taken image when the state detected by the state detector is the second state.

2. The image display device according to claim 1,
wherein the movable member is capable of selectively taking one of an open state and a closed state,
wherein the state detector is configured to detect that the state of the movable member is the first state, when the movable member is in the closed state, and
wherein the state detector is configured to detect that the state of the movable member is the second state, when the movable member is in the open state.

3. The image display device according to claim 1,
wherein the movable member configured to move between an open position and a closed position,
wherein the state detector is configured to detect that the state of the movable member is the first state, when the movable member is not moving between the open position and the closed position, and
wherein the state detector is configured to detect that the state of the movable member is the second state, when the movable member is moving between the open position and the closed position.

4. The image display device according to claim 1, wherein the controller is configured to control the display to display an alternative image instead of the taken image, when the state of the movable member is the second state, and the alternative image is an image created in advance.

5. The image display device according to claim 4, wherein the controller is configured to, when the state of the movable member is the second state, control the display to display an image representing a display state of the display, as the alternative image.

6. The image display device according to claim 5, wherein the image representing the display state of the display comprises an image representing that the display is in an OFF state in which the taken image is not displayed on the display.

7. The image display device according to claim 4, wherein the controller is configured to, when the state of the movable member is the second state, control the display to display an image representing that the state of the movable member is the second state, as the alternative image. S. The image display device according to claim 1, wherein the movable member is one of a trunk lid and a back door.
